(19) United States
(12) Patent Application Publication
(10) Pub. No.: US 2004/0200105 A1
(43) Pub. Date: Oct. 14, 2004

(54) Street sign directional indicator

(76) Inventor: Kim Kwee NG, Centereach, NY (US)

Correspondence Address: Kim Kwee NG, 10 Malibu Ln, Centereach, NY, 11720-3042, US

(21) Appl. No.: 10/151,141

(22) Filed: May 21, 2002

(51) Int. Cl. G09F 1/00; G09F 15/00

(52) U.S. Cl. 40/612; 40/607.01

(57) ABSTRACT

A directional indicator in the form of various graphic symbols is mounted on the street sign to denote the compass bearing direction of the street. A semi-circular dish, when used as a directional indicator to be mounted on the top edge of the street sign, denotes a northward direction pointing away from the street sign. The directional indicator mounted on the upper corner or the lower corner of the street sign represents respectively an eastward or a westward direction of the street. The directional indicator, when mounted at the bottom of the street sign, represents a southward direction of the street. Fluorescent coating or reflective material can be applied to the directional indicator to improve the visibility of the directional indicator at night.

### FIELD OF THE INVENTION

The invention relates generally to a device that will display directional information, in particular for a street sign or the like to convey the directionality of the sign in conjunction with the usual display of the street name and the like.

### DESCRIPTION OF THE PRIOR ART

It often happens that a person who is unfortunately lost at a cross-road, does not know the general directions of the roads at the junction. A shopper in multi-corridors in-door mall or a car driver emerging from a quiet lane, has an unfortunate task of deciding if a left hand turn or a right hand turn would be correct.

Street signs inscribed with the directional information are usually limited in scope and distribution to major roadways and intersecting road junction. U.S. Pat. No. 5,375,356, “Street sign with stripes”, describes the use of a street directional indicator for displaying both the name of the street and the direction thereof. The first street sign has a plurality of stripes inscribed on its surface. These stripes are oriented in a direction that corresponds to the direction of the first street. The stripes on the surface of the second street sign are oriented differently and correspond to the direction of the second street. In this way, the first street sign is distinguishable from the second street sign, even though both street signs are mounted on the same sign post oriented in the same direction. This prior art patent, however, does not display the actual compass bearing direction of the streets in question.

U.S. Pat. No. 4,662,096, “Display and street sign assembly having multi display faces”, discloses a street sign assembly that displays both the name of the street and the pictorial advertising media which is mounted on top of the street sign. This prior art patent does not include any directional indicator indicating the compass bearing direction of the street.

U.S. Pat. No. 4,837,569, “Traffic signal directional indicator device”, describes a directional indicator mounted on top of a traffic signal. The directional indicator displays a compass bearing direction indicating the direction the motorists are traveling. Such a device requires modification to the existing traffic light housing and is usually limited in scope to major highways and cross-roads.

A goal of the present invention is to remove the above deficiencies and difficulties by adding directional information to the street sign or the like, requiring only minor and inexpensive modifications.

Another goal of the present invention is to make the directional information easier to read and remember than the mere alphabetic characters or other types of letters inscribed on the surface of the sign.

It is desirable for a directional indicator bearing directional information be spotted and read from quite a distance away, even before the actual alphabetic characters inscribed on the sign are readable. This feature would enable a car driver sufficient time to decide before making a turn, or to make lane changes by studying the directional information on the street signs erected at the corner of each lane along the road on which the driver is travelling.

It is further suggested that fluorescent coating or reflective material be applied to the directional indicator, so that the directional indicator is visible at night to the driving public and other users of the road.

It is helpful and useful to convey such directional information in an unambiguous way to the driving public and pedestrians. Such a convenient and readily observable means would aid the road users, saving time and fuel for a travelling public.

These and other objects of the present invention will become apparent from the accompanying drawings and following detailed description of the invention.

### SUMMARY OF THE INVENTION

A directional indicator in the form of various graphic symbols is mounted on the street sign to denote a unique compass bearing direction of the street. A semi-circular dish, mounted on the top edge of the street sign, denotes a northward direction pointing away from the street sign. The eastward direction is represented by mounting the directional indicator at the upper corner of the street sign, while the westward direction is defined when the directional indicator is at the lower corner of the street sign. The directional indicator, when mounted at the bottom edge of the street sign, represents a southward direction. A bar, when mounted at an angle on the top edge of the street sign, represents either a northeast or a northwest direction of the street. The designation depends on the orientation of the bar with respect to the street sign. Fluorescent coating or reflective material can be applied to the directional indicator to improve the visibility of the directional indicator at night.

### BRIEF DESCRIPTION OF THE DRAWINGS

FIG. 1 is a simplified diagram of a first preferred embodiment showing a street sign mounting a directional indicator.

FIG. 2 is a simplified diagram showing a plurality of the street signs oriented to the north.

FIG. 3 is a simplified diagram showing a plurality of the street signs oriented to the east.

FIG. 4 is a simplified diagram showing a plurality of the street signs oriented to the west.

FIG. 5 is a simplified diagram showing a plurality of the street signs oriented to the south.

FIG. 6 is a simplified diagram showing a plurality of the street signs oriented to the northwest.

FIG. 7 is a simplified diagram of a second preferred embodiment showing a parking sign with a directional indicator.

FIG. 8 is a simplified diagram showing a plurality of identification signs indicating the direction of the stores and the directional indicators showing a compass bearing direction.

FIG. 9 is a simplified diagram showing a plurality of identification signs mounting several directional indicators.

### DESCRIPTION OF THE PREFERRED EMBODIMENTS

A more complete understanding of my invention may be obtained through a study of this description when taken together with the appended drawings, wherein like reference symbols refer to like elements of the drawings.

Referring now to the first preferred embodiment of my invention shown in FIG. 1, wherein a sign post 10, erected in a substantially upright position at a corner 20 of a road junction 25, comprises a street sign 30. The street sign 30 is preferably made of a sheet metal defining a generally elongated planar plate on which the name of the street and other identification are inscribed. The street sign 30 is generally bounded by a top edge 32, a bottom edge 34 and two adjacent lateral sides 36, 38. An observer 50 walking along the road 60 in the direction 70 sees the street sign 30. The street sign 30 contains a directional indicator 80 in the form of a graphic symbol 85. The graphic symbol 85 shown in FIG. 1 is a semi-circular dish 90 mounted on the right hand side and at the top edge 32 of the street sign 30. The directional indicator 80, residing at such a location 95, defines in the instant invention a compass bearing northward direction, “N”. The northward direction “N”, denoted by an arrow 100, is directed horizontally away from the street sign 30. The arrow 100, oriented in the plane of the street sign 30, is directed substantially parallel to the road surface 105 and away from the vertical side 38 of the street sign 30.

When the observer 50 makes a turn at the corner 20 and faces towards the North, in the direction indicated by the arrow 100, his/her raised right hand to the right is directed towards the East, “E”, as shown by the arrow 120. Similarly, his/her raised left hand to the left points to the West, “W”, as shown by the arrow 130. The South, “S”, denoted by the arrow 140, is pointing directly away from behind the observer's 50 back.

Fluorescent coating reflective material can be applied to the directional indicator 80 as shown by the dotted line 160. The dotted line 160 appears as an upper half circle representing a northward direction “N”. Such a coating would vastly improve the visibly of the directional indicator 80 at night.

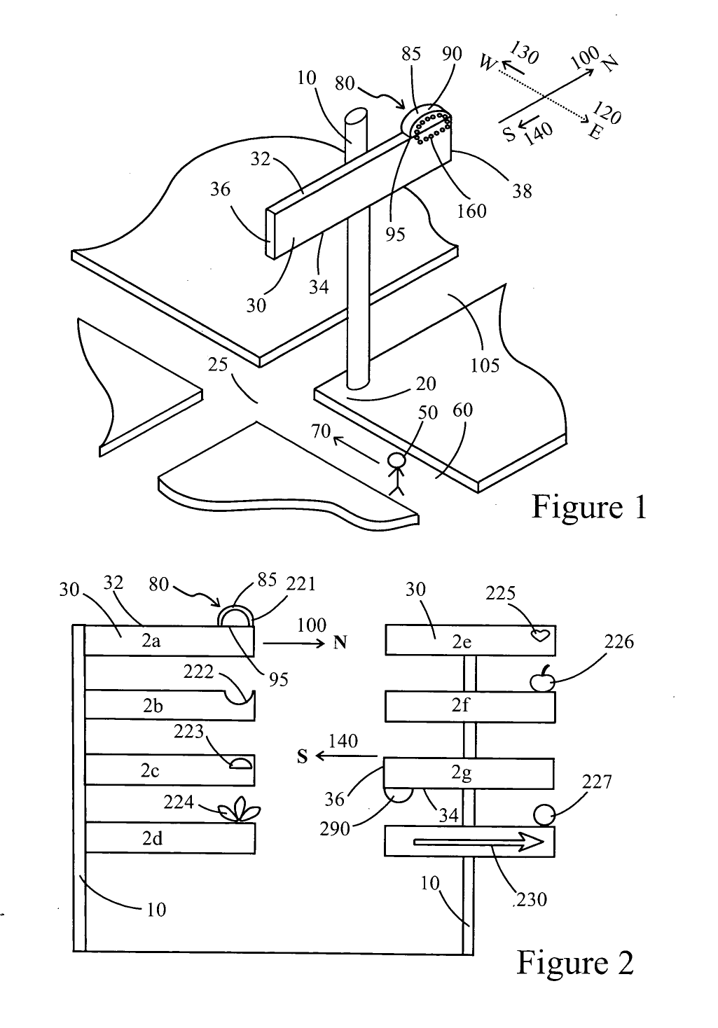

Referring now to FIG. 2, a plurality of street signs, mounted on the sign posts 10, comprises in each street sign 30 a directional indicator 80. Each directional indicator 80, in various graphic patterns or symbols 85, represents a compass bearing direction of the street sign 30. The directional indicator 80, mounted on the top edge 32 of the first street sign 30 with a label marked as 2a, is a hook-like object 221. The object 221 at this particular location 95 defines a northward direction, “N”, represented by the arrow 100 directed horizontally away from the street sign 30. The street sign 30 labeled as 2b has a cut-away semi-circular section 222 near the top edge 32 of the street sign 2b. A semi-circular through opening 223 is located near the upper edge 32 of the street sign 2c. Street sign 2d uses a flower 224 as an indicator. A heart-shaped through opening 225 is used as a directional indicator 80 for street sign 2e, so is the case for an apple 226 on the street sign 2f. A ball-like object or a dish 227 mounted on a one-way sign post 230 represents another type of the directional indicators 80. A directional indicator 290, mounted on the bottom edge 34 and situated on the left hand side of the street sign 2g, indicates a southward direction, “S”, represented by an arrow 140. The arrow 140, which is in the opposite direction of the North, “N”, is directed away from the left side 36 of the street sign 30.

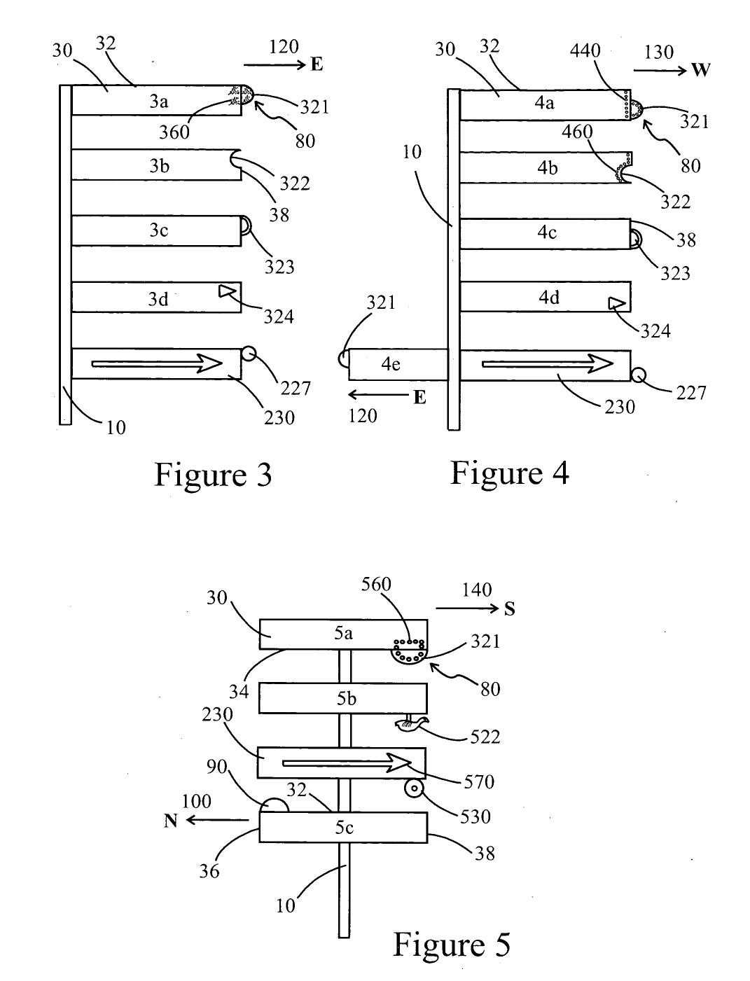

Similarly, as shown in FIG. 3, the directional indicator 80 for denoting the eastward direction, “E”, is mounted on the right upper corner of each street sign 30. The directional indicator 80, when counting from sign 3a downwardly, is represented respectively in each of the street sign 30 by a semi-circular plate 321, a semi-circular cut-away portion 322 from the right upper corner of the street sign 30, a hook 323, a triangular shape through opening 324 in the street sign 30 marked as 3d and a dish 227 on a one-way sign post 230. The eastward direction “E”, denoted by the arrow 120, is pointing away from the right side 38 of the street sign 30.

Fluorescent coating or reflective material can be applied to the directional indicator 80 as shown by the dotted line 360. The dotted line 360 extends further downwardly to form an alphabetic character, “P”. This would create a unique signature for an eastward/direction “E” so that the directional indicator 80 is visible at night. Many/other graphic symbols, for example, in the form of a tree-like object, an umbrella or other similar object, etc, can be substituted for displaying the directional information for the street sign and the like.

As shown in FIG. 4, the directional indicator 80 for denoting the westward direction, “W”, is mounted on the right lower corner of each street sign 30. The directional indicator 80, when counting from sign 4a downwardly, is represented respectively in each of the street sign 30 by a semi-circular plate 321, a semi-circular cut-away portion 322 from the right lower corner of the street sign 30, a hook 323, a triangular shape through opening 324 in the street sign marked as 4d and a dish 227 on a one-way sign post 230. The westward direction “W”, denoted by the arrow 130, is pointing away from the right side 38 of the street sign 30. The street sign marked as 4e, mounting a directional indicator 80 on the left upper corner of the street sign 4e, defines an eastward direction “E”. The compass bearing direction “E”, denoted by the arrow 120, points in the opposite direction of the West, “W”.

The dotted line 440 for fluorescent coating on the directional indicator 80 appears either as an alphabetic character “b” in sign 4a or a hook 460 in sign 4b, representing a westward direction “W”. Other graphic symbols, such as an inverted umbrella, may also be used.

As shown in FIG. 5, the directional indicator 80 for denoting the southward direction, “S”, is mounted at the bottom edge 34 of each street sign 30. The directional indicator 80, when counting from sign 5a downwardly, is represented respectively in each of the street sign 30 by a semi-circular plate 321, a bird-like symbol 522 and a coin-like object 530 with an eyelet at the center on a one-way sign post 230. The southward direction “S”, denoted by the arrow 140, is pointing away from the right side 38 of the street sign 30. A semi-circular dish 90, mounted on the top edge 32 of the street sign 5c, is on the left hand side of the street sign 5c. The semi-circular dish 90 defines a northward direction, “N”, directing away from the left side 36 of the street sign 5c.

The dotted line 560 for fluorescent coating on the directional indicator 80 appears as a bottom half circle representing a southward direction “S”. It is preferable to place the coin-like object 530 near the arrowhead 570 of the one-way sign post 230, so that it is consistent with the placement of the dish 227 on the one-way sign post 230 as illustrated in FIG. 2-4. It enhances the visibility of the one-way sign post 230 and sends a clear signal to the driver to note the importance in the directional message of the sign post 230.

Referring now to FIG. 6, a northwest direction, “NW”, for example, can be shown as a bar 621 mounted at an angle to the left on the top edge 32 of the street sign 30. Other directional indicators 80 for denoting a compass bearing direction in FIG. 6 are a leaf-like object 622 in sign 6b and a triangle shape opening 324 in sign 6c. The leaf-like object 622 at the bottom edge 34 of the sign 6d represents a southeast direction, “SE”, pointing in the opposite direction of the northwest direction, “NW”. Other directional information, for example, northeast or southwest, etc, can be similarly presented. The assignment of the directional indicator 80 depends on the orientation of the bar-like object 621 with respect to the street sign 30.

Referring now to the second preferred embodiment of my invention shown in FIG. 7, FIG. 8 and FIG. 9, wherein a directional indicator 80 is mounted to a planar sign 730 by a crimping bracket 740. A mall shopper 50 who sees the planar sign 730 in the middle of a parking lot (not shown) knows that he/she is facing a westward direction, denoted by an arrow 130. The directional indicator 80 defines a northward direction “N”, denoted by an arrow 100 pointing away from the lateral side 38 of the planar sign 730. The entrance he/she would be entering is the West entrance to a multi-corridors indoor mall (not shown) which usually has many other exits in several other different directions. The shopper 50 needs only to remember the directional indicator 80 which is mounted on the top edge of the planar sign 730 to find his/her direction in the mall.

After entering the mall, there are many identification signs bearing the names of the shops or an amenity. As shown in FIG. 8, one of the identification signs, 810, indicating the direction of the store, is labeled as “ABC Toys”. In addition to the posted sign 810, the identification sign 810 contains a directional indicator 80. The directional indicator 80 denotes a northward direction to his/her right. The northward direction is indicated by the arrow 100. The shopper 50 needs only to go straight ahead to find his/her car outside the mall. When the shopper 50 finds another identification sign 910 labeled as “Cinema” as shown in FIG. 9, he/she notices that the directional indicator 80, in the form of an eye-like object, denotes an eastward direction “E”. The eastward direction “E” points away from his/her right hand side. he/she would have to make a left turn and walks towards the exit in the westward direction to find the West entrance of the mall. Other graphic symbols 85 used for the directional indicator 80 are a smiling-face symbol 821, a car-like object 822 in FIG. 8 and a spool-like object 922 in FIG. 9.

The assignment of the observable directional indicator 80 in the foregoing embodiments follows closely to the traditional knowledge of the atlas and the compass. The direction, “N”, generally points upward on a map. It is noted that other assignments and placements of the directional indicator 80 on other parts of the street sign are possible. Though the assignment may not be rigidly defined, it is preferable that uniformity be maintained in placing and selecting the graphic symbols 85 for better visibility, consistency and interpretation.

1-9. (canceled)

10-25. (canceled)

26-38. (canceled)

39. A device for use in presenting directional information, comprising:
a) an elongated planar plate for use as an identification sign on which a name is inscribed; and
b) a graphic symbol mounted at a corner of said planar plate;
wherein said graphic symbol residing at said corner of said planar plate defines a directional indicator, said directional indicator denotes by assignment a compass bearing direction of said planar plate; said compass bearing direction is directed horizontally away from said planar plate and oriented in a plane of said planar plate.

40. The device of claim 39, wherein said directional indicator residing at a top edge of said planar plate denotes by assignment a northward direction, said northward direction is directed horizontally away from said planar plate.

41. The device of claim 39, wherein said directional indicator residing along a lateral side at an upper corner of said planar plate denotes by assignment an eastward direction, said eastward direction is directed horizontally away from said planar plate.

42. The device of claim 39, wherein said directional indicator residing along a lateral side at a lower corner of said planar plate denotes by assignment a westward direction, said westward direction is directed horizontally away from said planar plate.

43. The device of claim 39, wherein said directional indicator residing along a bottom edge of said planar plate denotes by assignment a southward direction, said southward direction is directed horizontally away from said planar plate.

44. The device of claim 39, wherein said directional indicator is coated with a reflective material.

45. The device of claim 39, wherein said directional indicator is coated with a fluorescent material.

46. A device for use in presenting directional information comprising:
a) an elongated planar plate for use as an identification sign on which a name is inscribed; and
b) a through opening being made in the form of a graphic symbol and located at a corner of said planar plate;
wherein said through opening located at said corner of said planar plate represents a directional indicator indicating a compass bearing direction of said planar plate; said compass bearing direction is directed horizontally away from said planar plate and oriented in a plane of said planar plate.

47. The device of claim 46, wherein said directional indicator residing along a lateral side at an upper corner of said planar plate denotes by assignment an eastward direction, said eastward direction is directed horizontally away from said planar plate.

48. The device of claim 46, wherein said directional indicator residing along a lateral side at a lower corner of said planar plate denotes by assignment a westward direction, said westward direction is directed horizontally away from said planar plate.

49. A device for use in presenting directional information, comprising:
a) an elongated planar plate for use as an identification sign on which a name is inscribed;
b) a graphic symbol mounted at a corner of said planar plate; and
c) a reflective material coated on said graphic symbol;
wherein said graphic symbol residing at said corner of said planar plate defines a directional indicator, said directional indicator denotes by assignment a compass bearing direction of said planar plate; said compass bearing direction is directed horizontally away from said planar plate and oriented in a plane of said planar plate.

50. The device of claim 49, wherein said directional indicator residing at a top edge of said planar plate denotes by assignment a northward direction, said northward direction is directed horizontally away from said planar plate.

51. The device of claim 49, wherein said directional indicator residing along a lateral side at a lower corner of said planar plate denotes by assignment a westward direction, said westward direction is directed horizontally away from said planar plate.
